(19) United States
(12) Patent Application Publication
(10) Pub. No.: US 2018/0281001 A1
(43) Pub. Date: Oct. 4, 2018

(54) PRESSURE WASHER INCLUDING SPRAY GUN WITH MULTIPLE FLUID RESERVOIRS

(71) Applicant: Briggs & Stratton Corporation, Wauwatosa, WI (US)

(72) Inventors: Tyler D. Masters, Butler, WI (US); Craig Serio, Wauwatosa, WI (US); Kyler Weid, Wauwatosa, WI (US)

(73) Assignee: Briggs & Stratton Corporation, Wauwatosa, WI (US)

(21) Appl. No.: 15/937,771

(22) Filed: Mar. 27, 2018

Related U.S. Application Data
(60) Provisional application No. 62/477,951, filed on Mar. 28, 2017.

(51) Int. Cl. B05B 7/04; B05B 7/30; B05B 7/32; B05B 11/00

(52) U.S. Cl. CPC B05B 7/0408; B05B 11/0078; B05B 7/32; B05B 7/30

(57) ABSTRACT

Systems and apparatuses include a prime mover, a pump driven by the prime mover, and a sprayer receiving a flow of water from the pump. The sprayer includes a sprayer housing, a first fluid reservoir coupled to the sprayer housing, a second fluid reservoir coupled to the sprayer housing, a chemical selector coupled to the sprayer housing and movable between a first chemical position and a second chemical position, a high pressure selector coupled to the sprayer housing and movable between a high pressure position and a chemical spray position, and a nozzle assembly in communication with the chemical selector and the high pressure selector.

### CROSS-REFERENCE TO RELATED PATENT APPLICATIONS

This application claims the benefit of U.S. Provisional Patent Application No. 62/477,951, filed Mar. 28, 2017, which is incorporated herein by reference in its entirety. This application is related to PCT Patent Application No. PCT/US2017/013145 filed on Jan. 12, 2017, which is incorporated herein by reference in its entirety.

### BACKGROUND

The present invention relates generally to pressure washers. More specifically, the present invention relates to pressure washers that are capable of spraying chemicals from a container.

### SUMMARY

One embodiment relates to a pressure washer that includes a prime mover, a pump driven by the prime mover, and a sprayer receiving a flow of water from the pump. The sprayer includes a sprayer housing, a first fluid reservoir coupled to the sprayer housing, a second fluid reservoir coupled to the sprayer housing, a chemical selector coupled to the sprayer housing and movable between a first chemical position and a second chemical position, a high pressure selector coupled to the sprayer housing and movable between a high pressure position and a chemical spray position, and a nozzle assembly in communication with the chemical selector and the high pressure selector.

Another embodiment relates to a pressure washer spray gun that includes a handle, a trigger operable by a user to selectively open a valve, a first fluid reservoir, a second fluid reservoir, a chemical selector movable between a first chemical position, a second chemical position, and a no-chemical position, a high pressure selector movable between a high pressure position and a chemical spray position, and a nozzle assembly in communication with the chemical selector and the high pressure selector.

Another embodiments relates to a pressure washer spray gun that includes a fluid reservoir, a chemical selector movable between a chemical position and a no-chemical position, a high pressure selector movable between a high pressure position and a chemical spray position, and a nozzle assembly in communication with the chemical selector and the high pressure selector and including a high pressure insert and a chemical insert. When the high pressure selector is arranged in the high pressure position, the high pressure insert is not in fluid communication with the chemical selector.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is a schematic diagram of a pressure washer, according to an exemplary embodiment;

FIG. 2 is a front, right, top pictorial view of a lance of the pressure washer of FIG. 1, according to an exemplary embodiment;

FIG. 3 is a rear, left top pictorial view of the lance of FIG. 2, according to an exemplary embodiment;

FIG. 4 is a front view of the lance of FIG. 2, according to an exemplary embodiment;

FIG. 5 is a top view of the lance of FIG. 2, according to an exemplary embodiment;

FIG. 6 is a right side view of the lance of FIG. 2, according to an exemplary embodiment;

FIG. 7 is a bottom view of the lance of FIG. 2, according to an exemplary embodiment;

FIG. 8 is a rear view of the lance of FIG. 2, according to an exemplary embodiment;

FIG. 9 is an exploded view of the lance of FIG. 2, according to an exemplary embodiment;

FIG. 10 is an exploded view of a chemical selector of the lance of FIG. 2, according to an exemplary embodiment;

FIG. 11 is an exploded view of a nozzle assembly of the lance of FIG. 2, according to an exemplary embodiment;

FIG. 12 is a front, right, top pictorial view of a nozzle block of the nozzle assembly of FIG. 11, according to an exemplary embodiment;

FIG. 13 is a rear, right, bottom pictorial view of the nozzle block of FIG. 12, according to an exemplary embodiment;

FIG. 14 is a section view of the nozzle block of FIG. 12 taken along line 14-14 of FIG. 12;

FIG. 15A is a sectional view of the lance of FIG. 2 taken along line 15-15 of FIG. 5 showing the high pressure selector in a high pressure position, according to an exemplary embodiment;

FIG. 15B is a sectional view of the lance of FIG. 2 taken along line 15-15 of FIG. 5 showing the high pressure selector in a chemical spray position, according to an exemplary embodiment;

FIG. 16 is a sectional view of the lance of FIG. 2 taken along line 16-16 of FIG. 6 showing a venturi path, according to an exemplary embodiment;

FIG. 17 is a sectional view of the lance of FIG. 2 taken along line 17-17 of FIG. 6 showing a low pressure bypass path, according to an exemplary embodiment;

FIG. 18 is a sectional view of the lance of FIG. 2 taken along line 18-18 of FIG. 6 showing a high pressure path, according to an exemplary embodiment;

FIG. 19 is a sectional view of the lance of FIG. 2 taken along line 15-15 of FIG. 5 showing the nozzle assembly, according to an exemplary embodiment;

FIG. 20 is a section view of the lance of FIG. 2 taken along line 17-17 of FIG. 6 showing connections between three fluid reservoirs, the chemical manifold, and the nozzle assembly, according to an exemplary embodiment; and

FIG. 21 is a section view of the lance of FIG. 2 taken along line 18-18 of FIG. 6 showing a high pressure path, according to an exemplary embodiment.

FIG. 22 is a section view of the lance of FIG. 2 taken along line 17-17 of FIG. 6 showing the chemical selector of FIG. 10 in a no-chemical position according to an exemplary embodiment.

FIG. 23 is a section view of the lance of FIG. 2 taken along line 17-17 of FIG. 6 showing the chemical selector of FIG. 10 in a first chemical position according to an exemplary embodiment.

FIG. 24 is a section view of the lance of FIG. 2 taken along line 17-17 of FIG. 6 showing the chemical selector of FIG. 10 in a second chemical position according to an exemplary embodiment.

FIG. 25 is a section view of the lance of FIG. 2 taken along line 17-17 of FIG. 6 showing the chemical selector of FIG. 10 in a third chemical position according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the drawings, a pressure washer is shown and described that includes a spray gun and a lance. The lance receives high pressure fluid (usually water) from the spray gun and includes three fluid reservoirs (e.g., chemical reservoirs), a nozzle assembly, and a chemical manifold that selectively connects one of the three fluid reservoirs to the nozzle assembly. The lance also includes a chemical selector that a user can manipulate to select which of the three reservoirs is connected to the nozzle assembly, and a high pressure selector that the user can manipulate to actuate the nozzle assembly between a high pressure mode where high pressure fluid is sprayed and no chemical is entrained in the spray, and a chemical spray mode where a chemical held within a selected fluid reservoir is entrained in a spray of reduced pressure.

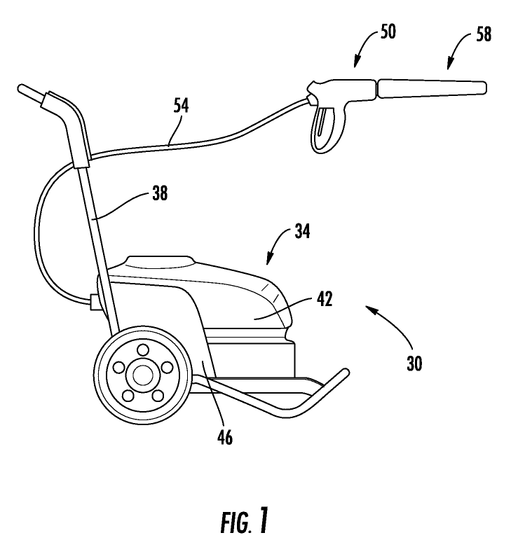

As shown in FIG. 1, a pressure washer 30 includes a base unit 34 with a frame 38 supporting a prime mover 42, such as an internal combustion engine or an electric motor, and a water pump 46 (e.g., positive displacement pump, piston water pump, axial cam pump). The pressure washer 30 further includes a sprayer in the form of a spray gun 50 and a multi-chemical lance 58. The spray gun 50 is coupled to the water pump 46 with a delivery conduit 54 (e.g., a high-pressure hose). The spray gun 50 includes a trigger for actuating a valve and may be similar to the pressure washer gun shown in U.S. Pat. No. 7,389,949, the entire disclosure of which is hereby incorporated by reference. In the illustrated embodiment, the multi-chemical lance 58 is separate from and fastened to the spray gun 50 so that fluid passes from the spray gun 50 through the multi-chemical lance 58. In other embodiments, the multi-chemical lance 58 may be incorporated into the spray gun 50.

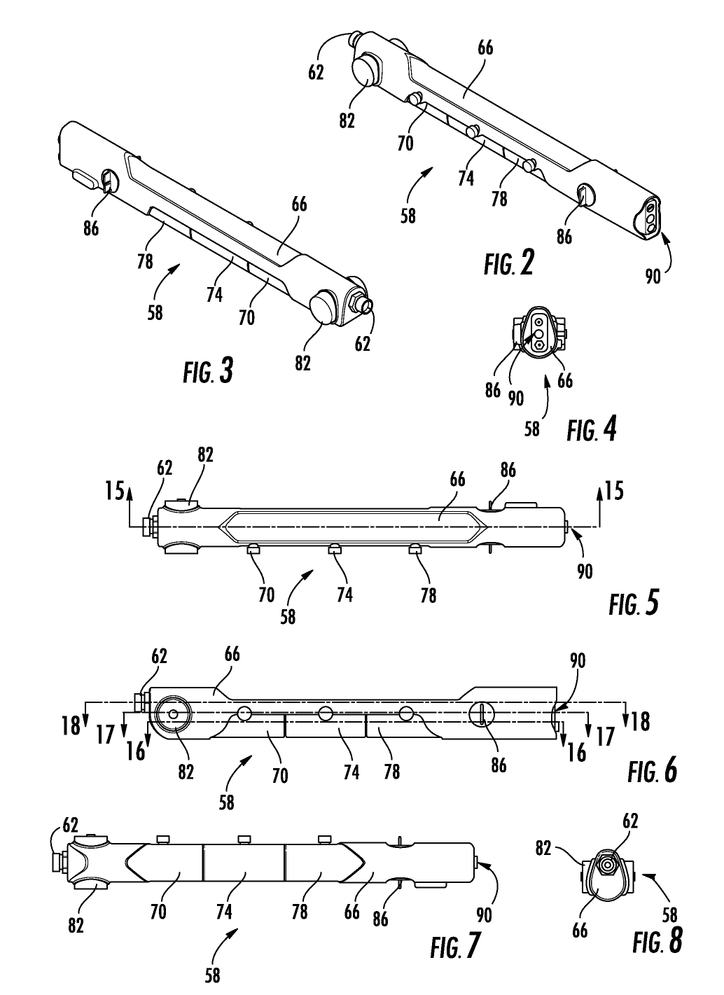

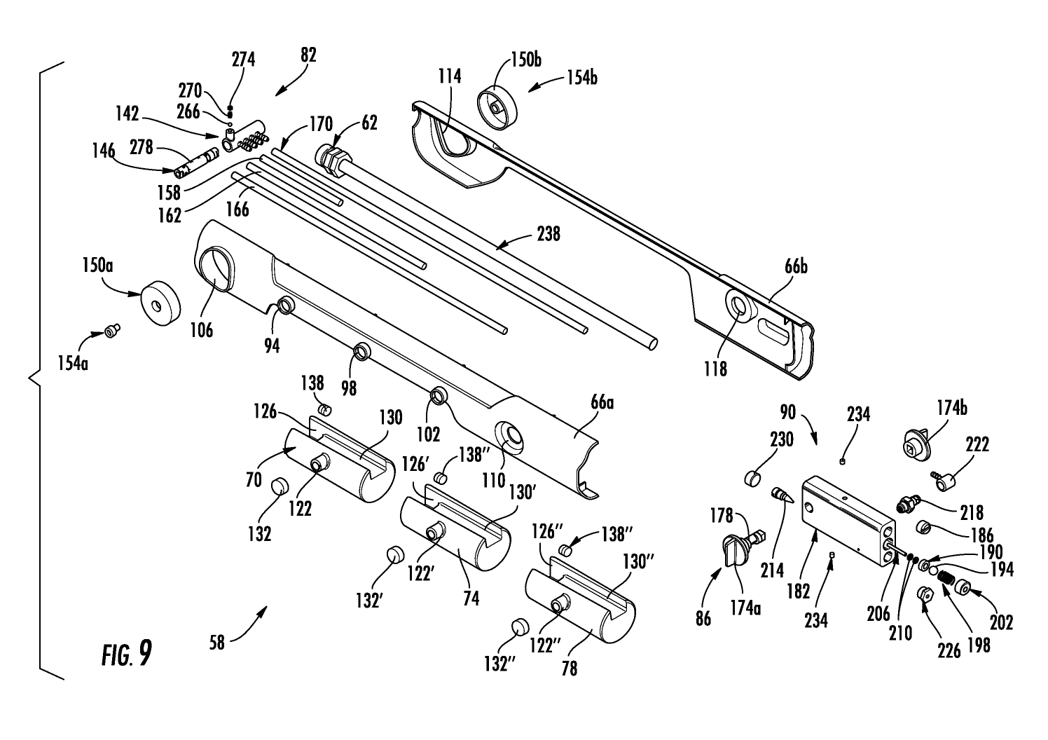

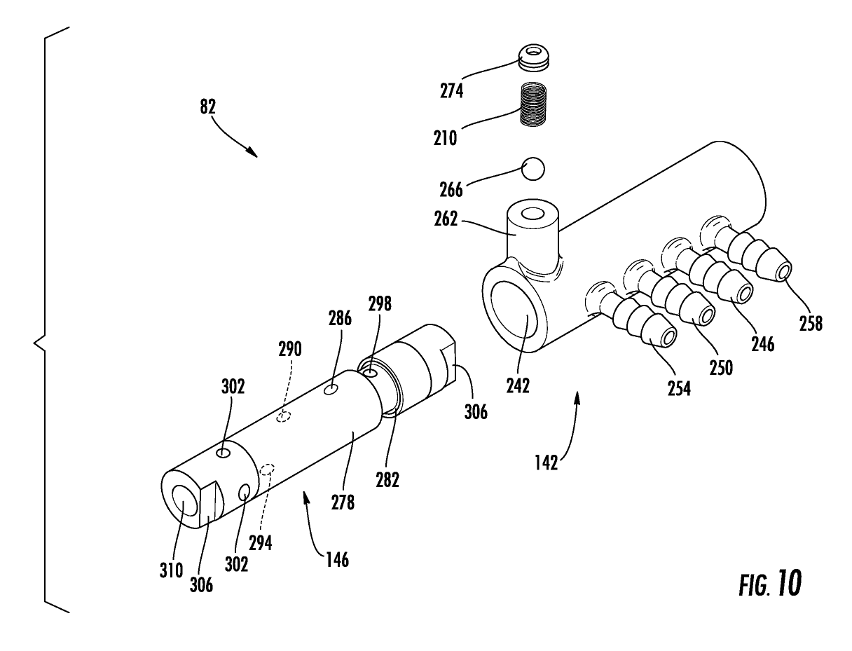

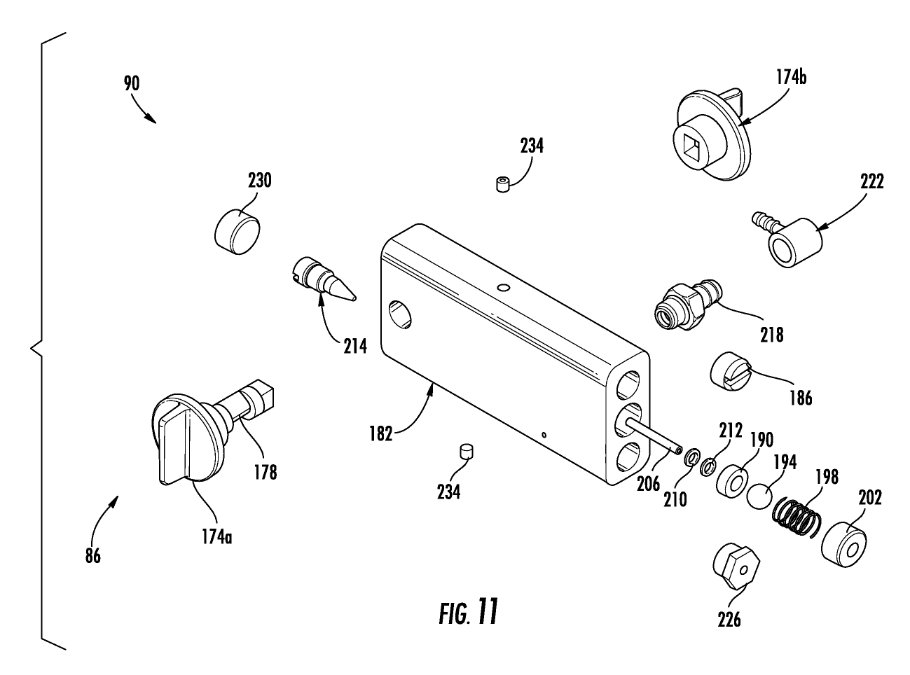

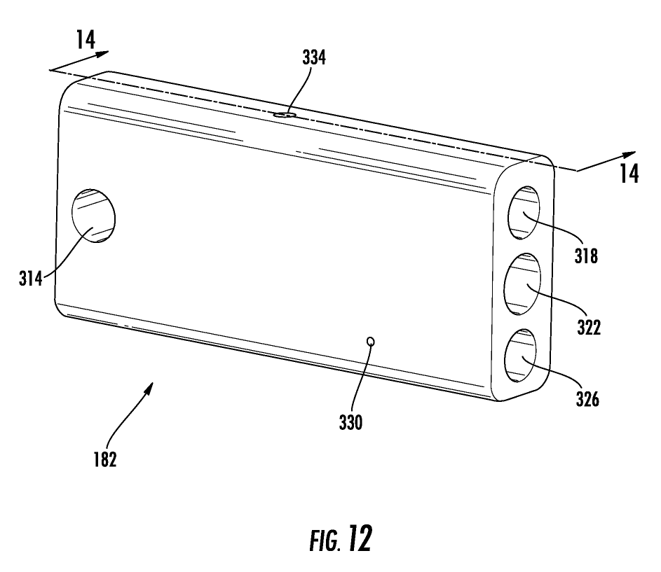

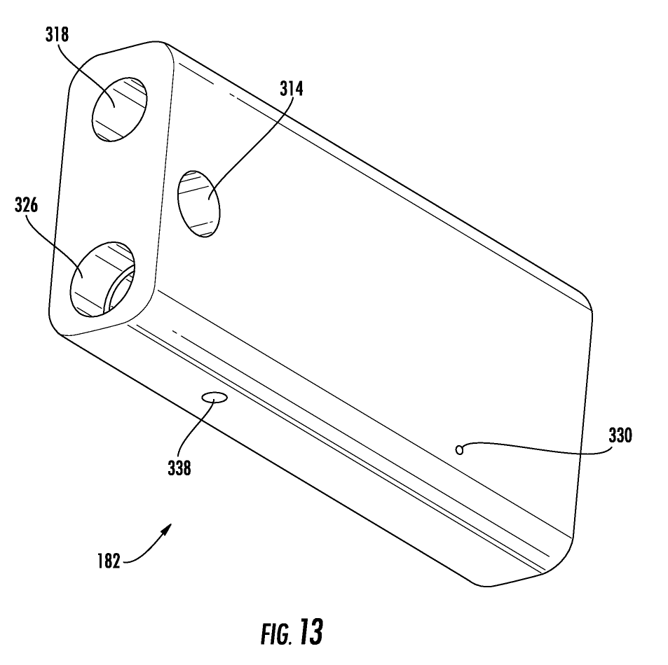

As shown in FIGS. 2-8, the lance 58 includes a coupling 62 structured to engage and fluidly couple the lance 58 to the spray gun 50. The illustrated coupling 62 is a threaded connection and includes a sealing gasket. In other embodiments, a quick connection, or another coupling type may be used. Additionally, the lance 58 may be formed as a part of the spray gun 50, as desired. The lance 58 also includes a housing 66, a first fluid reservoir 70, a second fluid reservoir 74, a third fluid reservoir 78, a chemical selector 82 that a user can manipulate to select a desired chemical, a high pressure selector 86 that the user can manipulate to select a high pressure mode or a chemical spray mode, and a nozzle assembly 90.

As shown in FIG. 9, the housing 66 includes a first housing 66a coupled to a second housing 66b by plastic welding, adhesion, fasteners, or another coupling method. The housing 66 holds and protects other components of the lance 58. The first housing 66a defines a first fill aperture 94, a second fill aperture 98, a third fill aperture 102, a first chemical selector aperture 106, and a first high pressure selector aperture 110. The second housing 66b includes a second chemical selector aperture 114 and a second high pressure selector aperture 118.

The first fluid reservoir 70 includes a stem 122 defining an opening, a connection recess 126, and a tubing recess 130. The stem 122 is sized to be received in the first fill aperture 94 of the first housing 66a and allows the user to fill the first fluid reservoir 70 with a desired chemical or additive (e.g., a pre-rinse, a detergent or soap, a rinsing agent, a wax). A cap 132 is sized to engage the stem 122 and inhibit liquid from escaping the first fluid reservoir 70 through the stem 122. In one embodiment, the cap 132 includes a duck valve, reed valve, check valve, or other mechanism for allowing air to enter the first fluid reservoir 70 while inhibiting liquid leakage. The connection recess 126 includes a connection aperture 134 (see FIG. 19) sized to receive a grommet 138. The first fluid reservoir 70 is constructed of a transparent or semi-transparent material that allows the user to view a fluid level within the first fluid reservoir 70.

The second fluid reservoir 74 and the third fluid reservoir 78 are substantially similar to the first fluid reservoir 70. Like parts on the second fluid reservoir 74 are labelled in the prime series and like parts on the third fluid reservoir 78 are labelled in the double prime series.

The chemical selector 82 includes a chemical manifold 142, a tumbler 146, and an actuator in the form of a first chemical dial 150a and a second chemical dial 150b connected to the tumbler 146 through the first chemical selector aperture 106 and the second chemical selector aperture 114, respectively. The first chemical dial 150a is connected to the tumbler 146 with a first fastener 154a, and the second chemical dial 150b is connected to the tumbler 146 with a second fastener 154b. Generally, the first chemical dial 150a and the second chemical dial 150b are manipulated by the user to move the tumbler 146 to select which fluid reservoir is arranged in fluid communication with the nozzle assembly 90.

A first tube 158 is sized to be connected to the chemical manifold 142 and pass through the grommet 138 of the first fluid reservoir 70 in order to provide fluid communication between the first fluid reservoir 70 and the chemical manifold 142. A second tube 162 is sized to be connected to the chemical manifold 142 and pass through the grommet 138′ of the second fluid reservoir 74 in order to provide fluid communication between the second fluid reservoir 74 and the chemical manifold 142. A third tube 166 is sized to be connected to the chemical manifold 142 and pass through the grommet 138″ of the third fluid reservoir 78 in order to provide fluid communication between the third fluid reservoir 78 and the chemical manifold 142. A fourth tube 170 is sized to be connected to the chemical manifold 142 and to provide fluid communication between the chemical manifold 142 and the nozzle assembly 90.

The high pressure selector 86 includes a first pressure dial 174a and a second pressure dial 174b. The first pressure dial 174a defines a cam profile 178 and is arranged to pass through the first high pressure selector aperture 110. The second pressure dial 174b is structured to be connected to the first pressure dial 174a and extend through the second high pressure selector aperture 118. The first pressure dial 174a and the second pressure dial 174b are sized so that the cam profile 178 is positioned within the nozzle assembly 90 when connected together.

The nozzle assembly 90 includes a nozzle block 182, a high pressure insert 186, a valve seat 190, a valve ball 194 sized to sealingly engage the valve seat 190, a biasing element in the form of a spring 198 biasing the valve ball 194 toward the valve seat 190, a valve plug 202, a valve pin 206 arranged to actuate the valve ball 194 away from the valve seat 190 against the bias of the spring 198, a seal 210 and a backer 212 are arranged to provide a fluid seal between the valve pin 206 and the nozzle block 182, a venturi nozzle 214, a first connector 218 and a second connector 222 structured to connect to the fourth tube 170 and provide fluid communication between the fourth tube 170 and the venturi nozzle 214, a chemical insert 226, a venturi plug 230, and two block plugs 234. A high pressure tube 238 fluidly connects the coupling 62 with the nozzle block 182.

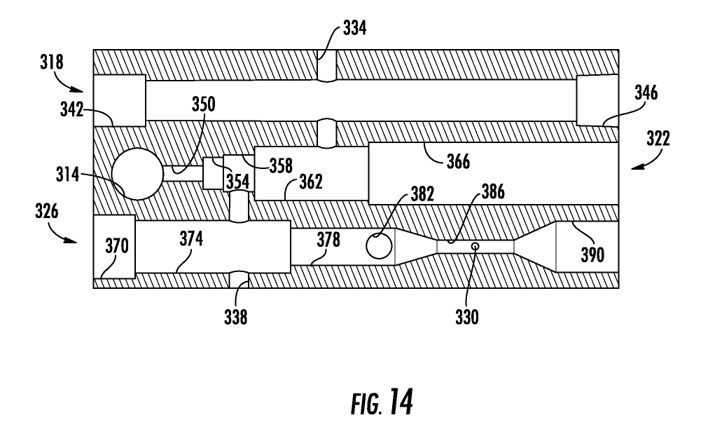

As shown in FIG. 10, the chemical manifold 142 defines an inner bore 242 and includes a first tube connector 246 arranged to receive the first tube 158, a second tube connector 250 arranged to receive the second tube 162, a third tube connector 254 arranged to receive the third tube 166, and a fourth tube connector 258 arranged to receive the fourth tube 170. The first tube connector 246, the second tube connector 250, the third tube connector 254, and the fourth tube connector 258 provide fluid communication with the inner bore 242. The chemical manifold 142 also includes a detent stem 262 sized to receive a detent ball 266, a detent spring 270, and a detent screw 274.

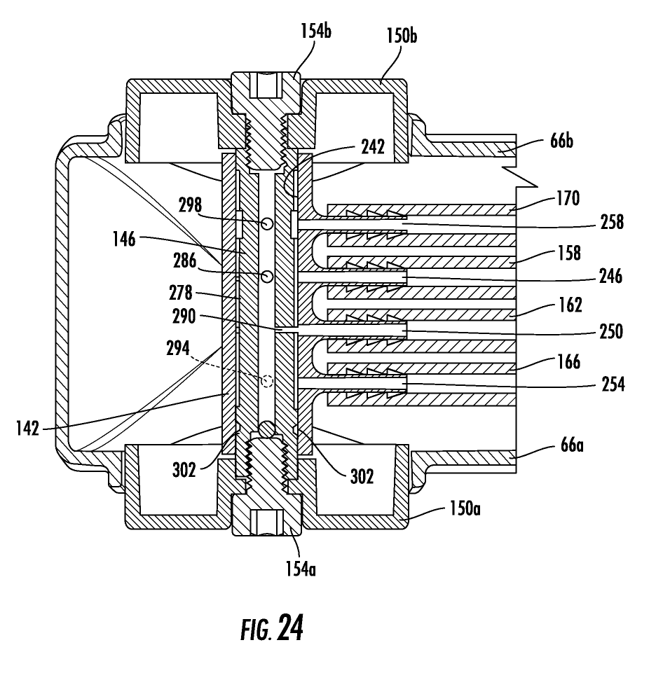

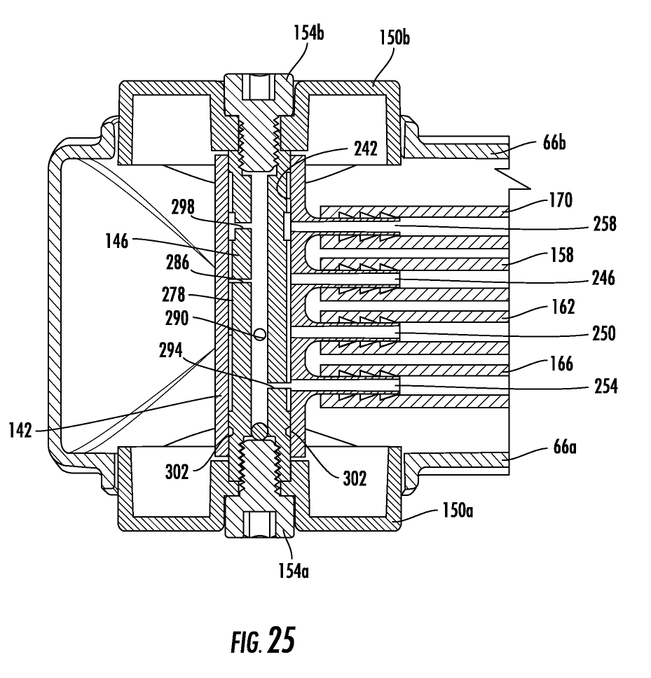

The tumbler 146 includes an overmolding 278 with an annular groove 282. The overmolding 278 is sized to sealingly engage the inner bore 242 while allowing the tumbler 146 to rotate within the inner bore 242 between a no-chemical position, a first chemical position, a second chemical position, and a third chemical position. The annular groove 282 is spaced along the tumbler 146 to align with the fourth tube connector 258 and does not seal against the inner bore 242 so that fluid may flow freely within the annular groove 282. A first chemical aperture 286 is arranged through the overmolding 278 and spaced along the tumbler 146 so that the first chemical aperture 286 aligns with the first tube connector 246 when the tumbler 146 is arranged in the first chemical position (see FIG. 23). A second chemical aperture 290 is arranged through the overmolding 278 (the second chemical aperture 290 is shown in broken lines and is positioned on the rear of the tumbler 146 as shown in FIG. 10) and spaced along the tumbler 146 so that the second chemical aperture 290 aligns with the second tube connector 250 when the tumbler 146 is arranged in the second chemical position (see FIG. 24). A third chemical aperture 294 is arranged through the overmolding 278 (the third chemical aperture 294 is shown in broken lines and is positioned on the bottom of the tumbler 146 as shown in FIG. 10) and spaced along the tumbler 146 so that the third chemical aperture 294 aligns with the third tube connector 254 when the tumbler 146 is arranged in the third chemical position (see FIG. 25). The first chemical aperture 286, the second chemical aperture 290, and the third chemical aperture 294 are separated by 90 degrees from one another, and each is arranged in communication with a chemical output aperture 298 positioned in the annular groove 282. When the tumbler 146 is arranged in the first chemical position, fluid communication is provided between the first fluid reservoir 70, the first tube 158, the first tube connector 246, the first chemical aperture 286, the chemical output aperture 298, the annular groove 282, the fourth tube connector 258, and the fourth tube 170. When the tumbler 146 is arranged in the second chemical position, fluid communication is provided between the second fluid reservoir 74, the second tube 162, the second tube connector 250, the second chemical aperture 290, the chemical output aperture 298, the annular groove 282, the fourth tube connector 258, and the fourth tube 170. When the tumbler 146 is arranged in the third chemical position, fluid communication is provided between the third fluid reservoir 78, the third tube 166, the third tube connector 254, the third chemical aperture 294, the chemical output aperture 298, the annular groove 282, the fourth tube connector 258, and the fourth tube 170.

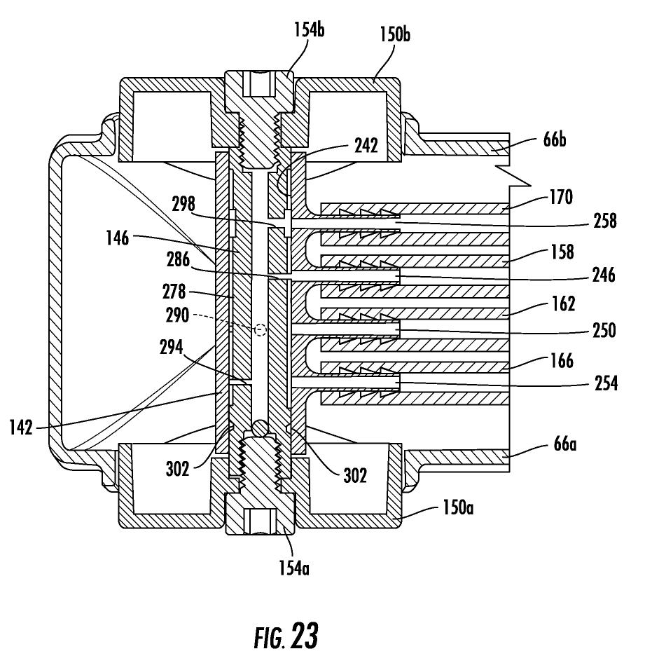

The tumbler 146 also includes four detent depressions 302 (two are visible in FIG. 10) arranged to interact with the detent ball 266 to inhibit unintentional actuation of the tumbler 146 and to improve alignment or actuation to the first chemical position, the second chemical position, and the third chemical position. In the illustrated example, the fourth detent depression 302 provides the no-chemical position, where there is no fluid reservoir in communication with the chemical output aperture 298 (see FIG. 22). In other embodiments, the tumbler 146 is replaced by a spool valve that slides within the manifold 142 or another directing element, as desired. Alternatively, the chemical selector 82 may be arranged communicate with more or less that three fluid reservoirs.

Keyway features in the form of double D keyways 306 are arranged at both ends of the tumbler 146 and sized to engage the first chemical dial 150a and the second chemical dial 150b. Threaded apertures 310 are arranged to receive the fasteners 154a and 154b to secure the first chemical dial 150a and the second chemical dial 150b to the tumbler 146.

FIG. 11 shows a detailed exploded view of the nozzle assembly 90. The high pressure insert 186 defines an aperture sized to provide a high pressure stream or jet of water or fluid. In some embodiments, high pressure insert 186 is a nozzle that provides a high pressure restriction of between 0-4200 psi, a flow rate of 0-5.0 GPM, and spray pattern of 0-40 degrees. In one embodiment, the high pressure insert 186 is a nozzle that provides a pressure restriction of at least 2000 psi, a flow rate of at least 2 GPM, and a fan spray pattern of 40 degrees. The chemical insert 226 defines a significantly larger aperture sized to provide a spray or other pattern of fluid flow to reduce the incidence of clogging when using clog prone chemicals (e,g., wax). In other words, the aperture of the chemical insert 226 defines a larger cross sectional area than the aperture of the high pressure insert 186. In some embodiments, the first connector 218 and the second connector 222 are replaced by a single elbow connector or another connection type.

As shown in FIG. 12, the nozzle block 182 defines a pressure selector bore 314 sized to receive the high pressure selector 86, a high pressure bore 318, an actuation bore 322, a chemical bore 326, a vent 330, and a first bypass bore 334. As shown in FIG. 13, the high pressure bore 318 and the chemical bore 326 pass fully through the nozzle block 182. A second bypass bore 338 is defined on a bottom side (as seen in FIG. 13) of the nozzle block 182.

As shown in FIG. 14, the high pressure bore 318 includes a high pressure tube receiving feature in the form of a threaded aperture 342 sized to engage the high pressure tube 238, and a high pressure insert receiving feature in the form of a threaded aperture 346 sized to engage the high pressure insert 186. The high pressure bore 318 provides fluid communication between the threaded aperture 342 and the threaded aperture 346.

The first bypass bore 334 is arranged transverse to the high pressure bore 318 and provides fluid communication to the actuation bore 322. The plug 234 is sized to threadingly engage and seal the first bypass bore 334.

The actuation bore 322 includes a pin aperture 350 that is in communication with the pressure selector bore 314 and sized to slidingly receive the valve pin 206. A pin sealing aperture 354 is positioned adjacent the pin aperture 350 and is sized to receive the seal 210 and the backer 212 and to support the seal 210 and backer 212 to provide a seal against the valve pin 206 to isolate the pressure selector bore 314 and the actuation bore 322. A downstream cavity 358 is positioned adjacent the pin sealing aperture 354, and an upstream cavity 362 is positioned adjacent to the downstream cavity 358. The upstream cavity 362 is sized to receive the valve seat 190, the valve ball 194, and the spring 198 so that the valve seat 190 abuts the downstream cavity 358 and the valve ball 194 moves to selectively inhibit fluid communication between the upstream cavity 362 and the downstream cavity 358. The valve ball 194 is sized smaller in diameter that the upstream cavity 362 so that fluid flow around the valve ball 194 is provided when the valve ball 194 is in an open position. An actuation plug cavity 366 is sized to receive the plug 202 and to isolate the upstream cavity 362 from the external environment. The first bypass bore 334 is arranged in communication with the upstream cavity 362.

The second bypass bore 338 is arranged transverse to the actuation bore 322 and provides communication between the downstream cavity 358 and the chemical bore 326. The plug 234 is sized to threadingly engage and seal the second bypass bore 338.

The chemical bore 326 includes a threaded aperture 370 sized to receive the plug 230, a primary stream cavity 374 in communication with the second bypass bore 338, a venturi bore 378 sized to receive the venturi nozzle 214, a chemical stream aperture 382 arranged in communication with the venturi bore 378 and transverse thereto, a throat 386 positioned downstream of the venturi bore 378 and the chemical stream aperture 382 and in communication with the vent 330, and a chemical insert aperture 390 sized to receive the chemical insert 226. The chemical aperture 382 is arranged in communication with the fourth tube 170 so that it can selectively receive fluid or chemicals from one of the three fluid reservoirs 70, 74, 78.

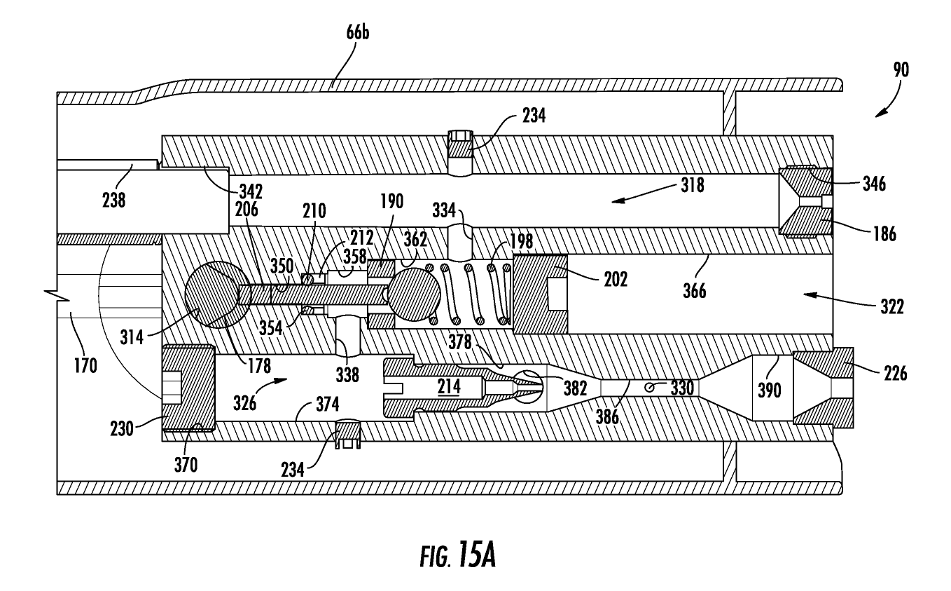

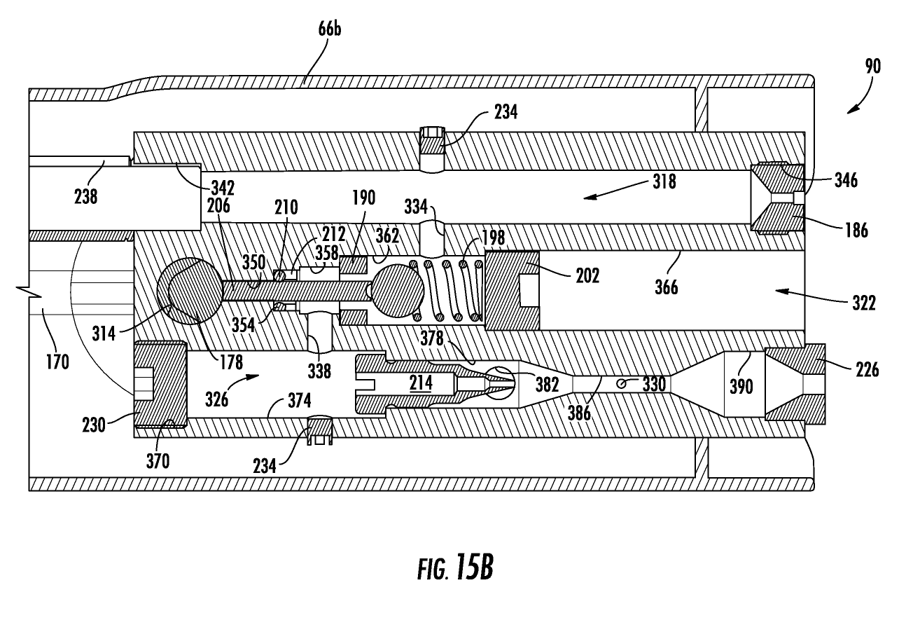

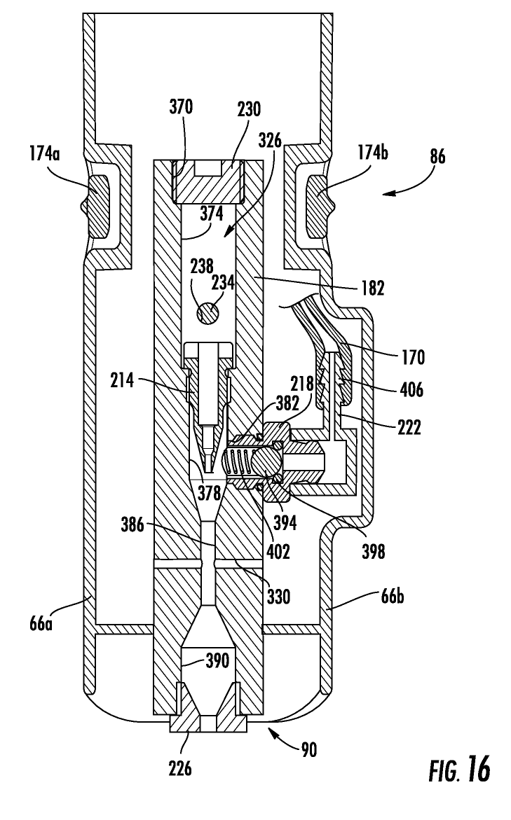

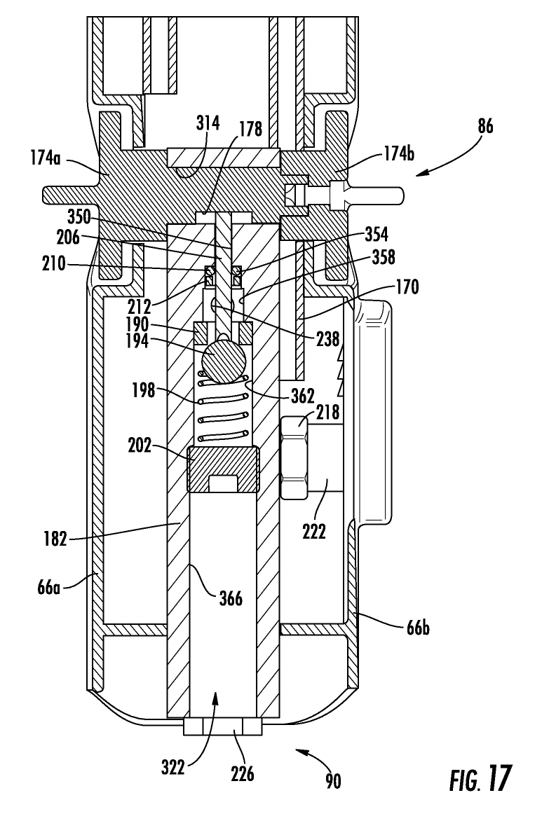

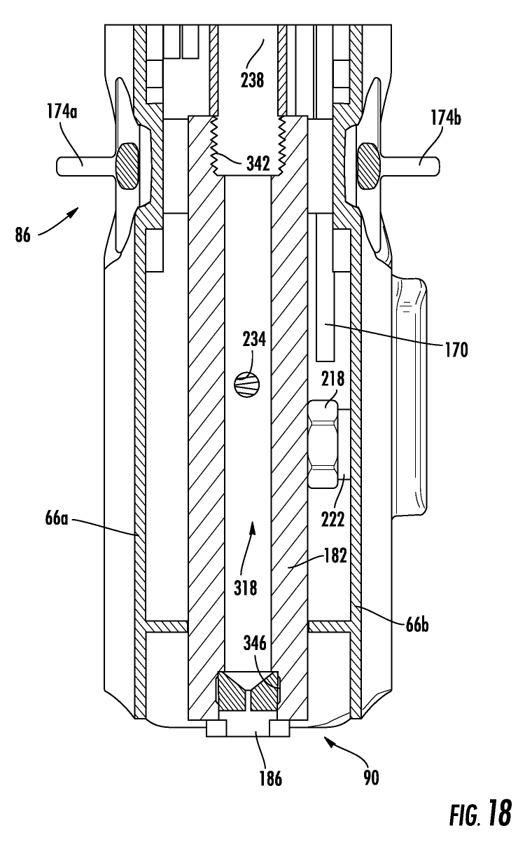

As shown in FIG. 15A, with the high pressure selector 86 arranged in a high pressure position, the cam profile 178 does not urge the valve pin 206 against the bias of the spring 198 and the valve ball 194 is maintained against the valve seat 190 so that communication between the upstream cavity 362 and the downstream cavity 358 is inhibited. When the high pressure selector 86 is arranged in the high pressure position, the high pressure bore 318 is isolated from the chemical bore 326 so that full pressure flow from the spray gun 50 is provided directly to the high pressure insert 186 from the coupling 62 via the high pressure tube 238 and the high pressure bore 318 of the nozzle block 182.

When the high pressure selector 86 is moved to a chemical spray position, as shown in FIG. 15B, the cam profile 178 is rotated about one-hundred-eighty degrees (180°) from the position shown in FIG. 15A so that the valve pin 206 is urged against the bias of the spring 198 to dislodge the valve ball 194 from the valve seat 190. A flow path is then provided from the high pressure bore 318, through the first bypass bore 334, the upstream cavity 362, past the valve ball 194 and the valve seat 190, the downstream cavity 358, the second bypass bore 338, and into the primary stream cavity 374. A primary stream of fluid then flows through the venturi nozzle 214 and a vacuum is formed in the chemical aperture 382 so that fluid or chemical is drawn from the fourth tube 170 and entrained in the primary stream to produce a chemical stream. The chemical stream then enters the throat 386 where air is drawn into the chemical stream through the vent 330 before the chemical stream is expelled through the chemical insert 226. In some embodiments, a foaming element may be placed in the chemical insert aperture 390 upstream of the chemical insert 226 to increase air entrapment. The foaming element may be a metal wool, a ceramic matrix, or another structure, as desired.

Positioning the high pressure selector 86 in the chemical spray position does not actively close the high pressure insert 186 or inhibit flow thereto. Rather, the relative diameters of the jets of the high pressure insert 186 and the chemical insert 226 produces a propensity to flow through the chemical pathway when possible so that no substantial flow exits the high pressure insert 186 when the high pressure selector 86 is in the chemical spray position. Alternatively, the cam/valve arrangement could be replaced with a diverter valve so that no fluid flows out of high pressure outlet.

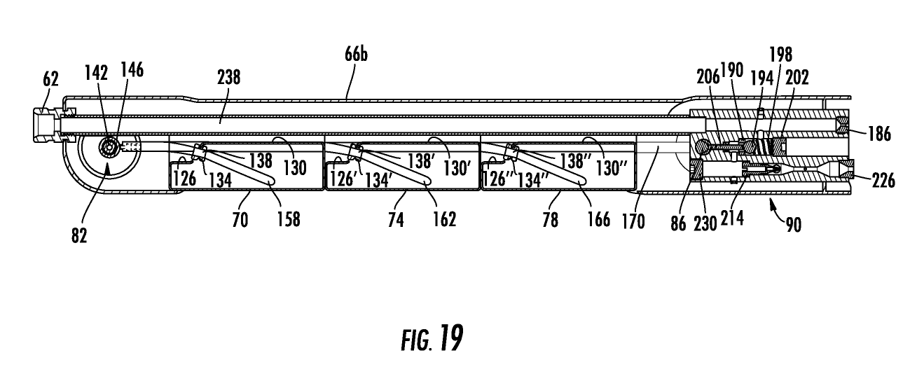

As shown in FIG. 16, the first connector 218 is sized to threadingly engage the chemical aperture 382 and includes a check valve in the form of a ball 394, a valve seat 398, and a spring 402 arranged to bias the ball 394 toward the valve seat 398. The spring 402 is sized such that the check valve is opened by the vacuum formed by the venturi nozzle 214. The second connector 222 is coupled to the first connector 218 and includes a connection in the form of a barbed fitting 406 sized to receive the fourth tube 170. In other embodiments, the first connector 218 and the second connector 222 are replaced by a single elbow fitting, as desired.

FIGS. 17 and 18 show the populated actuation bore 322 and the high pressure bore 318 respectively and make the assembly of the nozzle assembly 90 more clear.

Operation of the lance 58 is described with respect to FIG. 19. With the chemical selector 82 arranged in the no-chemical position, no flow path is provided through the chemical manifold 142 so that the first fluid reservoir 70, the second fluid reservoir 74, and the third fluid reservoir 78 are isolated from the nozzle assembly 90. When the chemical selector 82 is arranged in the no-chemical position, no chemicals or fluids will be entrained in the flow exiting the nozzle assembly 90. If the high pressure selector 86 is arranged in the high pressure position, fluid flows through the high pressure tube 238 and exits the high pressure insert 186. For example, water may be sprayed from the high pressure insert 186 for pressure washing. If the high pressure selector 86 is arranged in the chemical spray position (with the chemical selector 82 still arranged in the no-chemical position), then a low pressure spray is produced through the chemical insert 226. The low pressure spray can be used for low pressure applications such as rinsing, plant watering, or other applications where a low pressure stream or spray is desired.

The user can then rotate the chemical selector 82 to one of a first chemical position, a second chemical position, or a third chemical position. In alternate embodiments, one, two, four, or more chemical positions and corresponding chemical containers may be provided. The first chemical position aligns the first chemical aperture 286 of the tumbler 146 with the first tube connector 246 so that fluid communication is provided from the first fluid reservoir 70 through the chemical selector 82 and to the nozzle assembly 90. The second chemical position aligns the second chemical aperture 290 of the tumbler 146 with the second tube connector 250 so that fluid communication is provided from the second fluid reservoir 74 through the chemical selector 82 and to the nozzle assembly 90. The third chemical position aligns the third chemical aperture 294 of the tumbler 146 with the third tube connector 254 so that fluid communication is provided from the third fluid reservoir 78 through the chemical selector 82 and to the nozzle assembly 90.

When the chemical selector 82 is arranged in one of the first chemical position, the second chemical position, or the third chemical position and the high pressure selector 86 is arranged in the high pressure position, no chemical is entrained in the fluid flow, and high pressure fluid exits the high pressure insert 186. In other words, when the high pressure selector 86 is arranged in the high pressure position, the position of the chemical selector 82 does not affect the flow of fluid through the lance 58. When the high pressure selector 86 is in the chemical spray position, the vacuum is formed at the chemical stream aperture 382 and fluid or chemical is pulled from the selected fluid reservoir 70, 74, 78 and entrained in the fluid stream before exiting the chemical insert 226 as described above with respect to FIG. 15B.

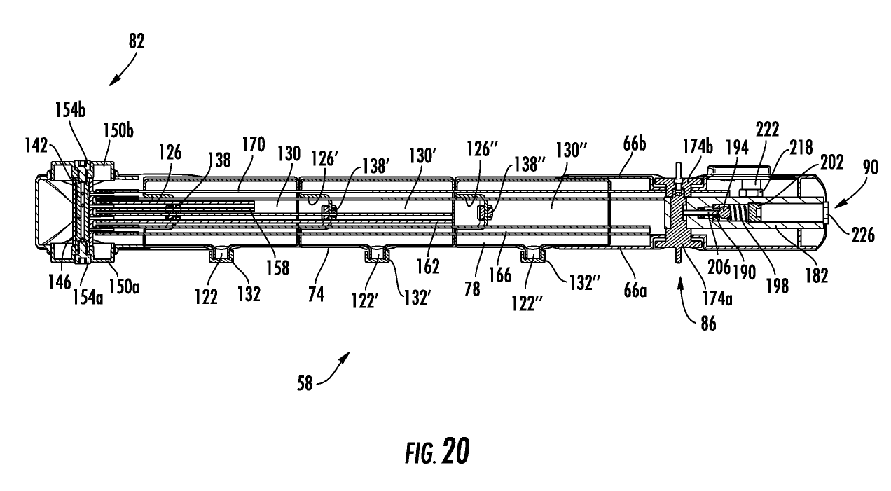

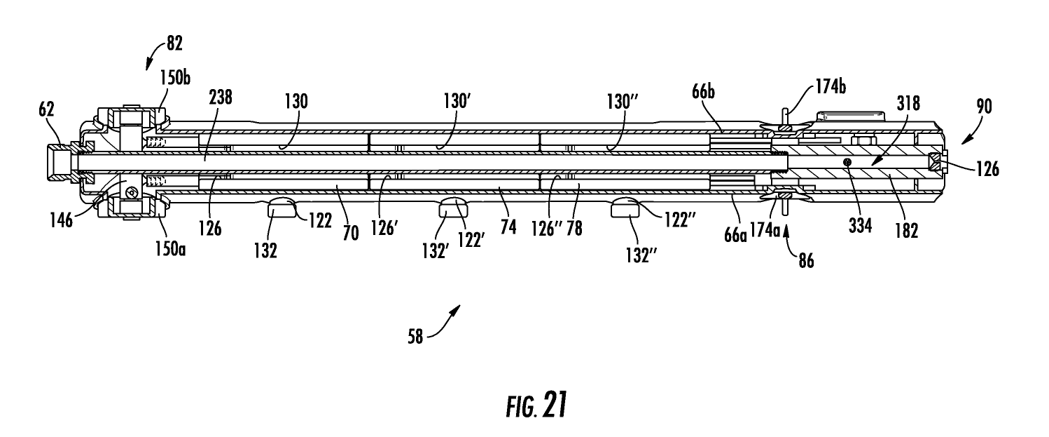

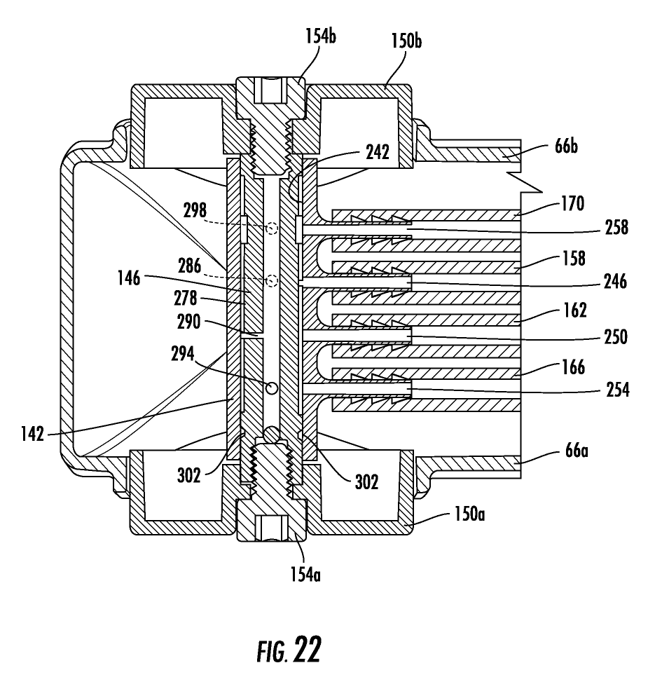

FIGS. 20 and 21 provide additional details concerning the construction and operation of the lance 58 according to the above embodiment.

The construction and arrangements of the pressure washer, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A pressure washer, comprising:
a prime mover;
a pump driven by the prime mover; and
a sprayer receiving a flow of water from the pump and including
a sprayer housing,
a first fluid reservoir coupled to the sprayer housing,
a second fluid reservoir coupled to the sprayer housing,
a chemical selector coupled to the sprayer housing and movable between a first chemical position and a second chemical position,
a high pressure selector coupled to the sprayer housing and movable between a high pressure position and a chemical spray position, and
a nozzle assembly in communication with the chemical selector and the high pressure selector.

2. The pressure washer of claim 1, wherein the nozzle assembly further includes a high pressure insert and a chemical insert, and
wherein when the high pressure selector is arranged in the high pressure position, the high pressure insert is not in fluid communication with the chemical selector.

3. The pressure washer of claim 1, wherein the chemical selector is further moveable to a no-chemical position, and
wherein when the chemical selector is arranged in the no-chemical position, fluid flow is inhibited between the first fluid reservoir, the second fluid reservoir, and the nozzle assembly.

4. The pressure washer of claim 1, wherein when the chemical selector is in the first chemical position and the high pressure selector is in the chemical spray position, fluid from the first fluid reservoir is entrained in the flow of fluid from the pump.

5. The pressure washer of claim 4, wherein the fluid from the first fluid reservoir is entrained in the flow of fluid from the pump within the nozzle assembly.

6. The pressure washer of claim 1, wherein the high pressure selector includes a cam that opens a valve within the nozzle assembly when the high pressure selector is arranged in the chemical spray position.

7. The pressure washer of claim 1, wherein the chemical selector includes a tumbler positioned within a manifold.

8. The pressure washer of claim 1, wherein the sprayer further includes a third fluid reservoir and the chemical selector is further moveable to a third chemical position.

9. A pressure washer spray gun, comprising:
a handle;
a trigger operable by a user to selectively open a valve;
a first fluid reservoir;
a second fluid reservoir;
a chemical selector movable between a first chemical position, a second chemical position, and a no-chemical position;
a high pressure selector movable between a high pressure position and a chemical spray position; and
a nozzle assembly in communication with the chemical selector and the high pressure selector.

10. The pressure washer spray gun of claim 9, wherein the nozzle assembly further includes a high pressure insert and a chemical insert, and
wherein when the high pressure selector is arranged in the high pressure position, the high pressure insert is not in fluid communication with the chemical selector.

11. The pressure washer spray gun of claim 9, wherein when the chemical selector is arranged in the no-chemical position, fluid flow is inhibited between the first fluid reservoir, the second fluid reservoir, and the nozzle assembly.

12. The pressure washer spray gun of claim 9, wherein when the chemical selector is in the first chemical position and the high pressure selector is in the chemical spray position, fluid from the first fluid reservoir is entrained in a flow of fluid exiting the nozzle assembly.

13. The pressure washer spray gun of claim 9, wherein the high pressure selector includes a cam that opens a valve within the nozzle assembly when the high pressure selector is arranged in the chemical spray position.

14. The pressure washer spray gun of claim 9, wherein the chemical selector includes a tumbler positioned within a manifold.

15. The pressure washer spray gun of claim 9, further comprising a third fluid reservoir and the chemical selector is further moveable to a third chemical position.

16. A pressure washer spray gun, comprising:
a fluid reservoir;
a chemical selector movable between a chemical position and a no-chemical position;
a high pressure selector movable between a high pressure position and a chemical spray position; and
a nozzle assembly in communication with the chemical selector and the high pressure selector and including a high pressure insert and a chemical insert,
wherein when the high pressure selector is arranged in the high pressure position, the high pressure insert is not in fluid communication with the chemical selector.

17. The pressure washer spray gun of claim 16, wherein when the chemical selector is arranged in the no-chemical position, fluid flow is inhibited between the fluid reservoir and the nozzle assembly.

18. The pressure washer spray gun of claim 16, wherein when the high pressure selector is arranged in the chemical spray position, fluid communication is provided to both the high pressure insert and the chemical insert.

19. The pressure washer spray gun of claim 16, wherein when the high pressure selector is arranged in the chemical spray position substantially all fluid flow exits the nozzle through the chemical insert.

20. The pressure washer spray gun of claim 16, wherein the high pressure selector includes a cam that opens a valve within the nozzle assembly when the high pressure selector is arranged in the chemical spray position.
